(19) United States
(12) Patent Application Publication
(10) Pub. No.: US 2008/0083596 A1
(43) Pub. Date: Apr. 10, 2008

(54) Clutch arrangement for a motor vehicle

(75) Inventors: Jorg Sudau, Niederwerrn (DE); Christoph Sasse, Schweinfurt (DE); Arthur Schroder, Hambach (DE); Rudiger Lotze, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/906,839

(22) Filed: Oct. 4, 2007

(30) Foreign Application Priority Data
Oct. 6, 2006 (DE) 10 2006 047 295.0

(51) Int. Cl. F16D 13/64

(52) U.S. Cl. 192/70.19

(57) ABSTRACT

A clutch device including a housing connected to a drive for rotation in common around an axis of rotation and fillable with a fluid; first friction elements connected to the housing by a first friction element carrier for rotation in common around the axis of rotation; second friction elements connected to a takeoff by a second friction element carrier for rotation in common around the axis of rotation; a piston element configured to exert a force so that the first and second friction elements frictionally engage each other; an abutment arrangement arranged on the first or second friction element carrier, the abutment arrangement providing a support for the first and second friction elements; and an elastic arrangement disposed in a path of force transmission between the piston element and the abutment arrangement and axially compressible when the piston element exerts the force on the first and second friction elements.

### BACKGROUND OF THE INVENTION

1. Field of the Invention

The present invention relates to a clutch arrangement for a motor vehicle, including a housing arrangement, which is to be connected to a drive unit for rotation in common around an axis of rotation and which is or can be filled with fluid; a first group of friction elements, which is connected to the housing arrangement by a first friction element carrier for rotation in common around the axis of rotation; a second group of friction elements, which is to be connected to a takeoff element by a second friction element carrier for rotation in common around the axis of rotation; a piston element, by means of which the friction elements of the first friction element group and the friction elements of the second friction element group can be brought into frictional engagement, wherein an abutment arrangement is provided on the first friction element carrier or on the second friction element carrier to produce a supporting action for the friction elements upon which the piston element exerts its force.

2. Description of the Related Art

In these types of clutch arrangements, also known as wet-running clutches or wet-running plate clutches, it is known that, to improve the closing process, i.e., to provide a defined closing movement with exertion of the appropriate pressure by the piston element, a spring element designed as a disk spring can be provided. During the clutch-engaging process, this spring generates a pretensioning force between the piston element and the friction element upon which the piston element exerts its force. The piston element must move against this pretensioning action so that it can actuate the friction element and thus produce the frictional interaction between the various friction elements. This spring element, which generates little or no interaction between the piston element and the friction element upon which the piston element acts and thus provides little or no force which could help engage the clutch, leads to the problem that, because of its closed, ring-like shape, it impairs the ability of the fluid to flow through the housing arrangement containing the various friction elements. Problems can therefore arise with respect to the cooling of the friction elements to be achieved by the circulation of the fluid.

### SUMMARY OF THE INVENTION

An object of the present invention is to provide a clutch arrangement for a motor vehicle in which the closing process of the clutch can be improved without impairing the ability of the fluid to flow through the housing arrangement.

This object is accomplished according to the invention by a clutch arrangement for a motor vehicle, including a housing arrangement, which is to be connected to a drive unit for rotation in common around an axis of rotation and which is or can be filled with fluid; a first group of friction elements, which is connected to the housing arrangement by a first friction element carrier for rotation in common around the axis of rotation; a second group of friction elements, which is to be connected to a takeoff element by a second friction element carrier for rotation in common around the axis of rotation; a piston element, by means of which the friction elements of the first friction element group and the friction elements of the second friction element group can be brought into frictional engagement. An abutment arrangement is provided on the first friction element carrier or on the second friction element carrier to produce a supporting action for the friction elements upon which the piston element exerts its force. An elastic arrangement which is axially compressible when force is exerted on the friction elements by the piston element is provided in the path along which the path of force between the piston element and the abutment arrangement.

In the inventive design of a clutch arrangement, therefore, the elastic effect is integrated directly into the force-absorbing path between the piston element and the abutment arrangement. No additional spring element, i.e., no spring element acting in parallel with the piston element, is required, which means that it is also possible to avoid the interference with the ability of the fluid present in the housing arrangement to flow around the friction elements.

For example, the elastic arrangement can comprise at least one cup-like shielded friction element of the first friction element group and/or of the second friction element group. Through this cup-like shielded design, each friction element shielded in this way is axially compressed when a compressive force is exerted on it and thus provides a counteracting force.

It is preferable for all the friction elements of the first friction element group or all the friction elements of the second friction element group to have this cup-like shielding. In this way, the elastic effect of a plurality of friction elements becomes additive, so that each individual friction element with cup-like shielding needs to be shielded to only a comparatively minor extent; nevertheless, through the sum of the individual elasticities, a comparatively large amount of axial elasticity can be integrated into the groups of friction elements.

In an especially advantageous embodiment, it is proposed that the friction elements of the first friction element group or the friction elements of the second friction element group have friction linings on both axial sides and that the minimum of one cup-like shielded friction element is a friction element with friction linings.

The abutment arrangement can comprise an axially elastic, ring-shaped element, which is supported by way of an axial locking element on a friction element carrier and which supports the friction elements in the axial direction. This ring-shaped element then forms at least part of the elastic arrangement.

In another variant of the inventive clutch arrangement, a friction element of the first friction element group or of the second friction element group comprises two disk parts, where a first disk part is essentially flat and provides a friction surface, and where the second disk part is designed with cup-like shielding and is supported axially by way of an axial locking element on a friction element carrier and thus forms at least part of the elastic arrangement.

The piston element, furthermore, can actuate the friction elements by way of a wavy, axially elastic ring-shaped element, which then forms at least a part of the elastic arrangement. This ring-shaped element can be connected essentially nonrotatably to a friction element carrier, to which a friction element also in contact with this ring-shaped element is connected essentially nonrotatably. Only an axial supporting action is therefore produced between this friction element and the ring-shaped element in contact with it, i.e., no circumferential movement is produced.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is described in greater detail below with reference to the attached drawings:

FIG. 1 shows a partial longitudinal cross section through a clutch arrangement;

FIG. 2 shows a partial cross section of a friction element used in the clutch arrangement of FIG. 1;

FIG. 3 shows an enlarged view of part of an alternative clutch arrangement in isolation;

FIG. 4 shows a view, corresponding to FIG. 3, of another alternative embodiment; and

FIG. 5 shows a view, corresponding to FIG. 3, of another alternative embodiment.

### DETAILED DESCRIPTION OF THE PREFERRED EMBODIMENTS

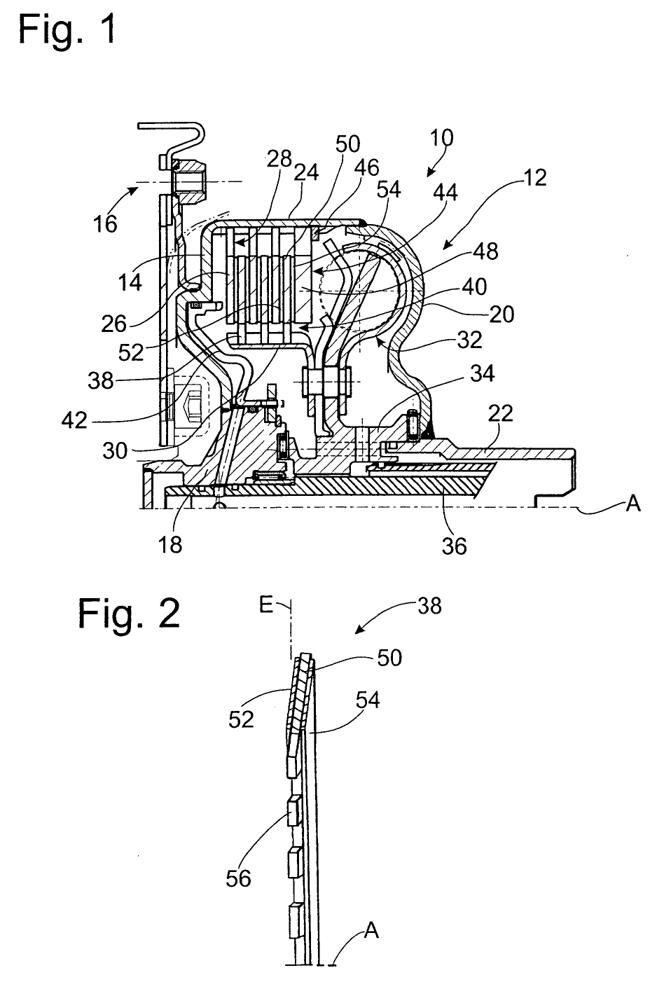

FIG. 1 shows a clutch arrangement, designated overall by the reference number 10. This arrangement comprises a housing arrangement 12 with a housing shell 14 on the engine side, which is connected nonrotatably by way of a connecting arrangement 16 to a crankshaft or the like, acting as a drive element. Radially on the inside, the engine-side housing shell 14 is permanently connected to a housing hub 18 by welding, for example. This housing hub 18 can be supported radially on the drive element. The housing arrangement 12 also comprises a gearbox-side housing shell 20, which is permanently connected radially on the outside by welding to the engine-side housing shell 14 and which, radially on the inside, is permanently connected by welding to a drive hub 22, which, in the assembled state of a drive train, engages in a gearbox, where it can drive a fluid pump.

The radially outer area of the housing shell 14 forms a first friction element carrier 24. The friction elements 26 of a first friction element group 28 are connected nonrotatably to this carrier 24 by engagement between sets of teeth but are able to shift position axially with respect to the carrier. A second friction element carrier 30 is connected by way of a torsional vibration damper arrangement 32 to a takeoff hub 34, which is connected nonrotatably in turn to a takeoff element 36 such as a gearbox input shaft by engagement between sets of teeth. Friction elements 38 of a second group 40 of friction elements are connected nonrotatably by engagement between sets of teeth to the second friction element carrier 30 but are able to shift position axially with respect to the carrier 30. It can be seen that, in this arrangement, the friction elements 26 of the first friction element group 28 and the friction elements 38 of the second friction element group 40 alternate with each other.

When axially displaced, the radially outer area of a piston element 42, which is supported on the housing arrangement 12 but is free to move in the axial direction, can press the friction elements 26 and 38 axially against each other, where an abutment arrangement 44 provides a support function, which produces a reactive force. This abutment arrangement 44 comprises a locking ring 46 attached to the first housing shell 14, i.e., to the first friction element carrier 24. A disk element 48, which acts as a friction element 26 of first friction element group 28, is supported axially against this ring.

So that torque can be transmitted from the housing arrangement 12 to the takeoff hub 34, the piston element 42 must therefore be shifted to the right in the diagram according to FIG. 1, so that it exerts force on the first friction element 26 of first friction element group 28 and thus pushes it against the adjacent friction element 38 of the second friction element group 40. In this way, the friction elements 26, 38 are pressed against each other while producing the supporting action of the abutment arrangement 44 and thus provide the torque-transmitting function as a result of the frictional interaction thus obtained.

It can also be seen in FIG. 1 that the friction elements 26 of the first friction element group 28 are made as essentially flat disk parts, fabricated out of sheet metal, for example. The friction elements 38 of the second friction element group 40 comprise a disk-like friction lining carrier 50, similar in design, for example, to the friction elements 26. This carrier 50 carries ring-like or ring segment-like friction linings 52, 54 on both axial sides. A friction element 26 of the first friction element group 28 not equipped with friction linings thus always alternates with a friction element 38 of the second friction element group 40 equipped with friction linings 52, 54.

A cross section of a friction element 38 of the second friction element group 40 of this type is shown on an enlarged scale in FIG. 2. It is possible to see the ring-like friction lining carrier 50, which has a set of teeth 56 on its inside circumference to establish the nonrotatable connection with the second friction element carrier 30. In its ring-like area radially adjacent to the set of teeth 56, this friction lining carrier 50 carries the friction linings 52, 54 on both axial sides. These linings 52, 54 can be attached by means of an adhesive, for example. It can also be seen that the friction element 38 is not flat but rather shielded in a cup-like manner when no force is being exerted on it. This means that this friction element 38 is at an angle to the plane E, which is essentially orthogonal to the axis of rotation A. Under axial load, that is, when a clutch-engaging operation is performed, the radially outer area of a friction element 38 of this type comes into contact with the immediately adjacent friction element 26 of the first friction element group 28, whereas the radially inner area comes in contact with the friction element 26 on the other axial side. Because of the inherent elasticity of the friction lining carrier 50, a friction element 38 of this type is compressed and generates a counterforce when the piston element 42 presses against it. Because preferably all of the friction elements 38 of the second friction element group 40 are provided with this type of cup-like shielding, their elasticities are additive, so that the axial elasticity providing the previously mentioned counterforce is integrated into the path of force absorption between the abutment arrangement 44, especially the locking ring 46 of that arrangement, and the piston element 42. As a result, the piston element 42 will act against a defined elasticity or counterforce when the clutch is being engaged, and this significantly increases the precision with which these types of clutch-engaging operations and the corresponding clutch-releasing operations can be conducted. The friction elements 38 of the second friction element group 40 therefore represent here an elastic arrangement acting in the path of absorption between the piston element 42 and the abutment arrangement 44.

It should be pointed out here that it would also be possible, of course, for the friction elements 26 of the first friction element group 28, i.e., the friction elements without friction linings, to have the cup-like shielding and/or to provide friction linings also or only on the friction elements 26 cooperating with the first friction element carrier 24 and possibly to design these friction elements 26, if desired, with cup-like shielding.

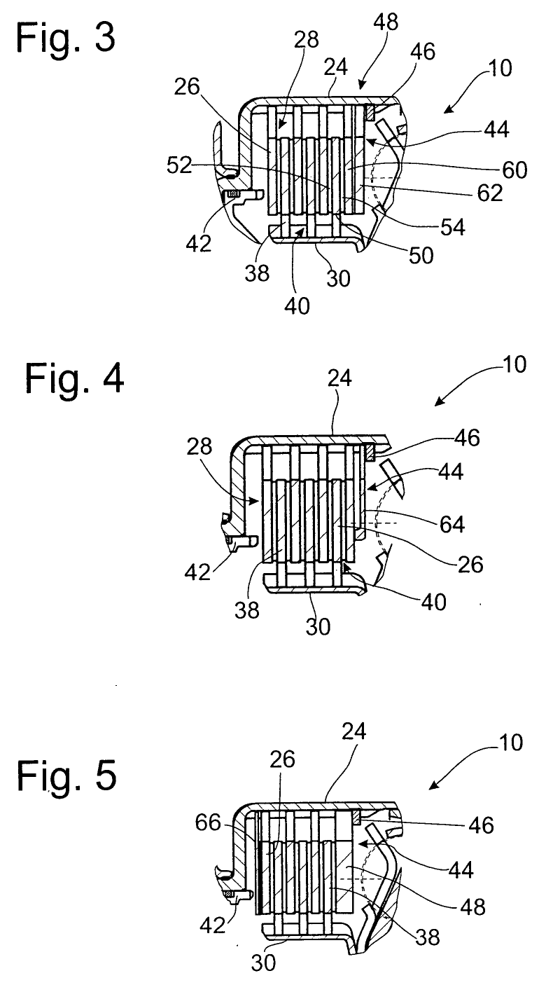

A modified embodiment of a clutch arrangement 10, the design of which can be basically the same as that shown in FIG. 1, is illustrated in FIG. 3. It can be seen here again that there are two friction element carriers 24, 30, the friction elements 26, 38 of the two friction element groups 28, 40 being connected nonrotatably to these carriers.

In embodiment shown in FIG. 3, the disk element 48, which can be interpreted as the last axial friction element 26 of the first friction element group 28 and also as a part of the abutment arrangement 44, is divided into two separate disks 60, 62. The separate disk 60 cooperating with a friction element 38 of the second friction element group 40 can be flat and can have exactly the same design as, for example, the other friction elements 26 of this friction element group 28. The other separate disk 62 can then have the cup-like shielded design, so that in particular the radially inner area of the separate disk 60, i.e., the area radially farther away from the friction element carrier 24, is supported. When the piston element 42 exerts force on it, the separate disk 62 can “give” axially and therefore provide the previously mentioned elasticity. The separate disk 62 can also have exactly the same design—except for the cup-like shielding—as the other friction elements 26 of the first group 28, which can provide a cost advantage in terms of manufacturing.

In the case of the design variant shown in FIG. 4, the abutment arrangement 44 comprises a ring-like, axially elastic support element 64. The area of this element farther away in the radial direction from the friction element carrier 24, that is, its radially inner area, supports the last axial friction element 26 of the first friction element group 28, and radially on the outside, where, for example, it is connected nonrotatably to the friction element carrier 24, it is supported axially against the locking ring 46. This ring-like support element 64 can be shaped out of sheet metal, but it can also be designed as a ring-shaped part fabricated by turning. In this variant, the friction elements 26 and 38 of the two groups 28 and 40 can then all be essentially flat, that is, without any cup-like shielding.

FIG. 5 shows a design variant in which the elastic arrangement present in the path of force absorption between the piston element 42 and the abutment arrangement 44 is provided essentially by a ring-like, circumferentially wavy spring element 66. This is supported against the first axial friction element 26, that is, the element 66 immediately adjacent to the piston element 42, and its radially outer area is engaged for rotation in common with the friction element carrier 24. The force exerted by the piston element 42 on this ring-like spring element 66, which there has the design of a wave washer or spring washer, acts on the crests of the waves facing away from the directly adjacent friction element 26, and thus the wave crests facing the directly adjacent friction element 26 are pressed against that element 26. An axial elasticity can thus also be integrated in this way into the path of force transmission between the piston element 42 and the abutment arrangement 44 without producing any frictional interaction between the ring-like spring element 66 and the friction element 26 upon which it acts.

It should be pointed out in conclusion that, of course, the various aspects of providing an elastic arrangement in the path of force between the piston element and the support arrangement can be combined with each other, and/or the cooperation with the two friction element carriers 24, 30 can be reversed. In the case of the exemplary embodiments shown here, however, it is especially advantageous for the piston element 42, which can be connected essentially nonrotatably to the housing arrangement 12, to cooperate directly with a component which is also connected nonrotatably to the housing arrangement 12, that is, for example, with a friction element 26 or, in the case of the embodiment according to FIG. 5, with the ring-like spring element 66. It is also advantageous for the abutment arrangement 44 to be effective with respect to the housing arrangement 12, as a result of which the friction element carrier 30 connected via the torsional vibration damper arrangement 32 to the takeoff hub 34 can be kept essentially free of axial forces.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch device comprising:
a housing connected to a drive for rotation in common around an axis of rotation, the housing being fillable with a fluid;
a first friction element carrier;
a plurality of first friction elements connected to the housing by the first friction element carrier for rotation in common around the axis of rotation;
a second friction element carrier;
a plurality of second friction elements connected to a takeoff by the second friction element carrier for rotation in common around the axis of rotation;
a piston element which is configured to exert a force so that the first friction elements and the second friction elements frictionally engage each other;
an abutment arrangement arranged on one of the first and second friction element carriers, the abutment arrangement providing a support for the first and second friction elements when the piston element exerts the force on the first and second friction elements; and
an elastic arrangement disposed in a path of force transmission between the piston element and the abutment arrangement, the elastic arrangement being axially compressible when the piston element exerts the force on the first and second friction elements.

2. The clutch device of claim 1, wherein at least one friction element of the first and second friction elements is cup-shaped, the elastic arrangement comprising the at least one friction element.

3. The clutch device of claim 1, wherein all of the first friction elements or all of the second friction elements are cup-shaped, the elastic arrangement comprising the cup-shaped friction elements.

4. The clutch device of claim 2, wherein each of the first friction elements or each of the second friction elements comprises two axial sides and a friction lining on each of the two axial sides, the at least one friction element being a friction element having the friction linings.

5. The clutch device of claim 3, wherein each of the cup-shaped friction elements comprises two axial sides and a friction lining on each of the two axial sides.

6. The clutch device of claim 1, wherein the abutment arrangement comprises an axial locking element attached to the first friction element carrier, and an axially elastic ring element supported axially by the axial locking element, the elastic arrangement comprising the axially elastic ring element.

7. The clutch device of claim 1, wherein the abutment arrangement comprises an axial locking element attached to one of the first and second friction element carriers, one friction element of the first and second friction elements comprising two disk elements, one of the disk elements being essentially flat and comprising a friction surface, the other of the disk elements being cup-shaped and being supported axially by the axial locking element, the elastic arrangement comprising the other of the disk elements.

8. The clutch device of claim 1, wherein the elastic arrangement comprises an axially elastic ring-shaped spring element having circumferential waves or undulations, the piston element exerting the force on the first and second friction elements via the elastic ring element.

9. The clutch device of claim 8, wherein both the elastic ring element and the first friction elements are attached essentially nonrotatably to the first friction element carrier.
